(19) United States
(12) Patent Application Publication
(10) Pub. No.: US 2004/0085915 A1
(43) Pub. Date: May 6, 2004

(54) Protocol performance using ACK priority

(76) Inventors: Yuval Gronau, Tel Aviv (IL); Lior Storfer, Tel Aviv (IL); Arik Gal, Kfar Vitkin (IL)

Correspondence Address: DANA L. BURTON, TEXAS INSTRUMENTS INCORPORATED, P.O. BOX 655474, MS 3999, DALLAS, TX, 75265, US

(21) Appl. No.: 10/287,222

(22) Filed: Nov. 4, 2002

(51) Int. Cl. H04L 12/28

(52) U.S. Cl. 370/282; 370/457

(57) ABSTRACT

A method and system are provided for improving performance in a communication system comprising: requesting a first service ID 30 and a second service ID 32 from an upstream termination system 14; using the first service ID 30 to service upstream data packet 28 transmissions; and using the second service ID 32 to service upstream acknowledge packet 20 transmissions providing an approach by which ACK packets 20 acknowledging downstream packets 18 are not queued behind data packets 28 in the upstream channel 26. Other systems and methods are disclosed.

### FIELD OF THE INVENTION

This invention generally relates to communication systems, and more specifically to systems and methods for improving protocol performance.

### BACKGROUND OF THE INVENTION

DOCSIS 1.0 was the first step towards getting IP connectivity over cable to the home. It was a focused effort to provide best-effort type of service needed for data/Internet connectivity, with web-surfing and file downloading being the most dominant applications. DOCSIS 1.1 focused on enabling different types of services to work well on top of the cable access. Features like bandwidth and latency guarantees were essential for the delivery of voice. The work of defining DOCSIS 1.1 was an extensive effort. The end result of this work was the creation of a specification that, more than anything else, is a set of tools. These tools enable the establishment of different types of service flows needed by different applications. Although DOCSIS 1.1 focused on voice, the tools of DOCSIS 1.1 bring significant value in other traffic scenarios. One of the most common traffic scenarios is data connectivity to the Internet. The most recent iteration is DOCSIS 2.0, which continues the effort to provide improved tools.

Referring to FIGS. 1 and 4, most common applications (i.e. web surfing, FTP) run over TCP, which is connection-based. Data 18 that flows over the cable downstream 24 from a server 10 to the client side PC 12 requires an acknowledgement 20 to be sent back. In an FTP “get,” for example, typical packet size in the downstream direction is 1518 bytes while the ACKs are 64 bytes.

TCP works with a sliding window. A few packets are sent from the server 10, which then expects to receive ACKs 20 (generally one ACK for each 2 packets received by the end PC 12). If the server does not receive an ACK 20 after it has already sent out a “window” number of bytes, it stops sending and waits for the ACK 20. The high throughput potential of the downstream path 24 (40 mbit/sec in 256 QAM modulation) is bottlenecked by the transmission of ACKs 20 on the upstream direction 26.

DOCSIS 1.1 defines different types of services. Of these, the most commonly used are Best Effort for data transmission and Constant Bit Rate for voice. Best Effort service, as the name suggests, does not guarantee a particular level of throughput or latency. These depend on the load of the system as well as the physical parameters with which the system is configured to work. The request-grant handshake for best effort data limits the number of bursts per second that may be transmitted. This is the bottleneck of the upstream channel 26.

Both the PC 12 and server 10 affect the performance of TCP. The PC 12 advertises its receive window size. If the size of the TCP receive window is small, the server 10 will only transmit a small window of packets 18 each RTT. This will result in short bursts of downstream 24 traffic with relatively long delays between them while the server 10 waits for ACKs 20 to arrive from the upstream 26.

### SUMMARY OF THE INVENTION

In general, and in a form of the present invention methods and systems are provided for improving performance in a communication system. In accordance with the present invention, a method is provided for improving performance in a communication system comprising the steps of: requesting a first service ID and a second service ID from an upstream termination system; using the first service ID to service upstream data packet transmissions; and using the second service ID to service upstream acknowledge packet transmissions. In an embodiment the second service ID is given transmission priority. In addition, in a form of the present invention a method for improving performance in a communications system is provided comprising the steps of: transmitting a request for an acknowledge wherein the request for the acknowledge is transmitted prior to receiving one or more data packets the acknowledge will be acknowledging. A data packet may be transmitted with the request for an acknowledge. In yet another form of the present invention, a method for improving performance in a communications system is provided comprising the steps of: transmitting a grant for an acknowledge wherein the grant for the acknowledge is transmitted before the grant for the acknowledge is requested. A grant for a data packet or a data packet may be transmitted with the grant for the acknowledge.

### BRIEF DESCRIPTION OF THE DRAWINGS

Particular embodiments in accordance with the invention will now be described, by way of example only, and with reference to the accompanying drawings in which like reference signs are used to denote like parts and in which:

FIG. 1 is a block diagram of an exemplary cable modem communication system in which the present invention may be practiced;

FIG. 2 is a representation of upstream transmission without the present invention;

FIG. 3 is a representation of upstream transmission in an embodiment of the present invention;

FIG. 4 is a representation of data transmission direction in an exemplary cable modem communication system;

FIG. 5 is a representation of an embodiment of the present invention using multiple SIDs;

FIG. 6 is a representation of upstream piggyback transmission in an embodiment of the present invention; and

FIG. 7 is a representation of downstream piggyback transmission in an embodiment of the present invention.

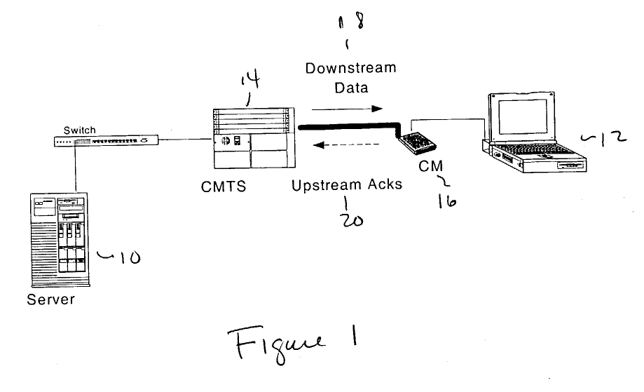

Corresponding numerals and symbols in the different figures and tables refer to corresponding parts unless otherwise indicated.

### DETAILED DESCRIPTION OF EMBODIMENTS OF THE INVENTION

Although the invention finds particular application to cable modem systems and a TCP protocol, it also finds application to other forms of communication systems and protocols.

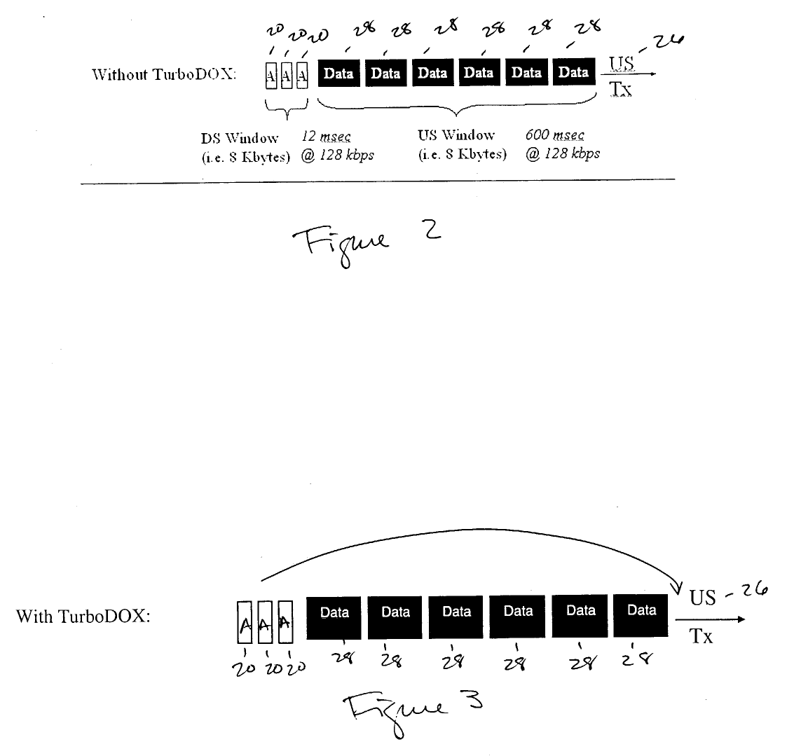

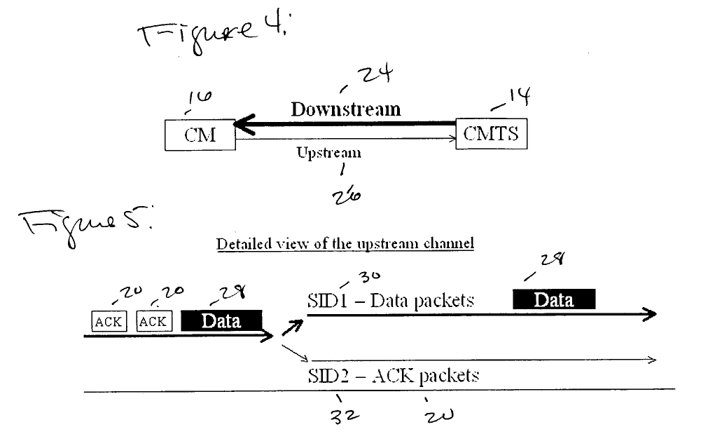

Referring to FIG. 2, simultaneous TCP upload and download sessions from a single cable modem 16 may result in a significant reduction of the download rate compared to the case where there is no upstream session. The reason for this is that both data packets 28 of the upload session and ACK packets 20 acknowledging the download data 18 share a common upstream channel 26. ACK packets 20 may be delayed in queues behind data packets 28 before they can be transmitted on the upstream channel 26. Such delays increase the return trip time and consequently, reduce the TCP download rate.

Prior art systems use one Service ID (SID) for both the upload data packets and the ACKs using techniques known as “ACK first”, “backpressure” and “priority scheduling”. These techniques allocate more bandwidth to ACKs at the expense of the upload data. Other prior art systems request a grant for an ACK only after a download data packet has arrived and should be acknowledged.

Referring to FIG. 3, in embodiments of the present invention different techniques are provided by which the ACK packets 20, acknowledging the downstream packets 18, are not queued behind data packets 28 in the upstream channel 26. In an embodiment, as shown in FIG. 5, the cable modem 16 requests two Service IDs 30, 32 (SIDs) from the Cable Modem Termination System 14 (CMTS). One SID 30 is used to service the upload data packets 28 and the second SID 32 is used to service the ACKs 20. In this manner, an ACK 20 that arrives after a data packet 28 may be transmitted before it. It is not delayed by waiting for the data packet 28 to be transmitted in the relatively slow upstream channel 26. This reduces the return trip time of the ACK 20 and increases the downstream 24 rate. In addition, the upload rate of data packets 28 is increased, because the data packets 28 do not share a common upstream 26 SID with the ACK packets 20. This approach separates the data 28 and ACKs 20 to different SIDs 30,32. Therefore, allocation of bandwidth to the ACKs 20 does not reduce the available bandwidth to the upload data 28. Optionally, other techniques, for example those that reduce the total load on the upstream channel 26, may be used in conjunction with the technique described above. Requesting two SIDs 30, 32 used alone or in combination with other mechanisms can result in a significantly increased downstream 24 rate and an increased upstream 26 rate, with only very limited increase to the load on the upstream channel 26.

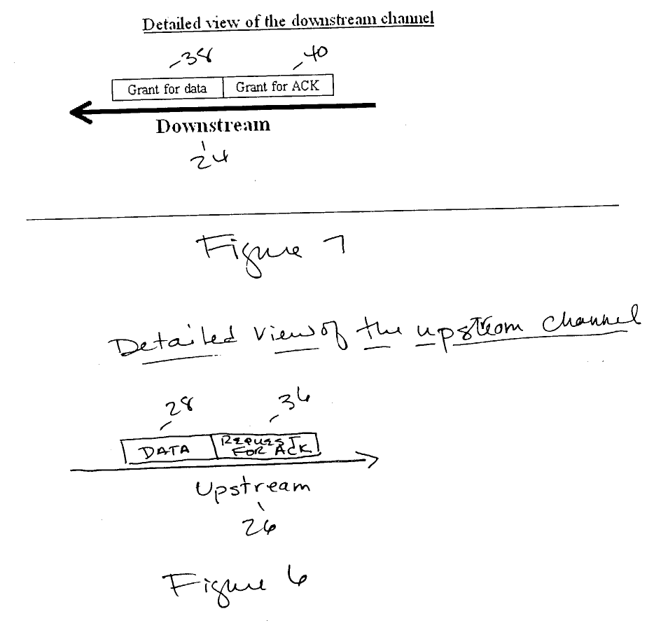

In circumstances when there are simultaneous upload and download sessions, a piggyback request 36 for allocation of transmission slots may be attached to a packet 28 that is sent on the upstream channel 26, as shown in FIG. 6. The request 26 is for an ACK 20 for a data packet 18. The grant 40 for that request 36 is used for transmitting an ACK 20 for the next data packet or packets 18. The request may be sent even prior to the arrival of a data packet 18 that should be acknowledged, based on the assumption that such a data packet 18 will arrive by the time that the grant 40 is received. In such a manner, the request-grant cycle is shortened. This reduces the return trip time of the ACK 20 and increases the resulting downstream 24 rate. Similarly, referring to FIG. 7, the grant 40 for the ACK 20 may be piggybacked on the grant 38 for the data package 18. It may be piggybacked even if a grant 40 for an ACK 20 is not requested based on the assumption that the download continues and an ACK 20 will be sent. Pre-requesting 36 transmission grants 40 before a data packet 18 arrives, or pre-granting 40 the ACK 20 before a request 36 is made, shortens the request-grant cycle and increases the downstream 24 rate.

These embodiments may be used in conjunction with the approaches described above to improve efficiency further. The approaches provided herein, used either singly or in combination, result in a minimum delay of ACKs 20 acknowledging downstream data packets 18 in the upstream 26 queues. This reduces the return trip time of the ACK 20 and significantly increases the resulting downstream 24 rate. The downstream 24 rates achieved by using the described techniques when there are simultaneous upload and download sessions may be increased by an order of magnitude compared to the case when these techniques are not employed. The downstream 24 rates obtained by use of the described techniques when there are simultaneous upload and download sessions may be comparable to the downstream 24 rates that are obtained when there is only a download session and there is no upload session.

When two Service IDs 30,32 are used, the total bandwidth available to the cable modem 16 for transmission of the upload data 28 and the ACKs 20 is increased compared to the case where only one SID is shared for data packets 28 and ACKs 20. This increases both the download rate and the upload rate. In addition, it solves the problem of “ACK choking” or “data starvation” that may result from allocating a significant amount of the upstream 26 bandwidth to the ACKs 20 at the expense of the data packets 28. As the total bandwidth required by the ACKs 20 is not significant compared to the bandwidth allocated to the data packets 28, the total load on the upstream channel 26 is not increased significantly.

By requesting 36 a grant 40 to transmit an ACK 20 even before the downstream data packet 18 to be acknowledged arrives or by granting 40 an ACK 20 before a request 36 arrives, the request-grant process is shortened. This ensures that when the downstream packet 18 does arrive and an ACK 20 is generated, the ACK 20 does not have to wait unnecessary time in a buffer waiting for the request 36 to be sent and the grant 40 to arrive. This shortens the round trip time and consequently increases the downstream 24 rate.

While the invention has been described with reference to illustrative embodiments, this description is not intended to be construed in a limiting sense. Various other embodiments of the invention will be apparent to persons skilled in the art upon reference to this description. For example, the embodiments are described in the context of a cable modem system. However, the invention could be used in other types of communication systems. As an additional example, the embodiments are described in the context of a TCP protocol and ACK packets. However, the invention could be applied to other appropriate protocols and elements.

It is therefore contemplated that the appended claims will cover any such modifications of the embodiments as fall within the true scope and spirit of the invention.

What is claimed is:

1. A method for improving performance in a communication system comprising the steps of:
a. requesting a first service ID and a second service ID from an upstream termination system;
b. using the first service ID to service upstream data packet transmissions; and
c. using the second service ID to service upstream acknowledge packet transmissions.

2. The method of claim 1 wherein the second service ID is given transmission priority.

3. The method of claim 1 wherein the acknowledge packet is acknowledging receipt of one or more downstream data packets.

4. The method of claim 1 wherein the request for the first service ID and the second service ID is made by a cable modem.

5. The method of claim 1 wherein the upstream termination system is a cable modem termination system.

6. A method for improving performance in a communications system comprising the steps of:
transmitting a request for an acknowledge wherein the request for the acknowledge is transmitted prior to receiving one or more data packets the acknowledge will be acknowledging.

7. The method of claim 6 wherein a data packet is transmitted with the request for an acknowledge.

8. The method of claim 6 wherein the transmitting is on an upstream channel.

9. The method of claim 6 wherein the communication system is a cable modem system.

10. A method for improving performance in a communications system comprising the steps of:
transmitting a grant for an acknowledge wherein the grant for the acknowledge is transmitted before the grant for the acknowledge is requested.

11. The method of claim 10 wherein a grant for a data packet is transmitted with the grant for the acknowledge.

12. The method of claim 10 wherein a data packet is transmitted with the grant for the acknowledge.

13. The method of claim 10 wherein the transmitting is on a downstream channel.

14. The method of claim 10 wherein the communication system is a cable modem system.
